(19) United States
(12) Patent Application Publication
(10) Pub. No.: US 2024/0317590 A1
(43) Pub. Date: Sep. 26, 2024

(54) METHOD FOR PRODUCING PHOSGENE

(71) Applicant: BASF SE, Ludwigshafen am Rhein (DE)

(72) Inventors: Jan Pablo JOSCH, Ludwigshafen am Rhein (DE); Stefan ENGELS, Ludwigshafen am Rhein (DE); Gerhard OLBERT, Ludwigshafen am Rhein (DE); Torsten MATTKE, Ludwigshafen am Rhein (DE)

(21) Appl. No.: 18/580,641

(22) PCT Filed: Jul. 13, 2022
(86) PCT No.: PCT/EP2022/069554

§ 371 Date: Jan. 19, 2024

(30) Foreign Application Priority Data
Jul. 23, 2021 (EP) 21187476.3

(51) Int. Cl. C01B 32/80; B01J 21/18; B01J 37/08

(52) U.S. Cl. CPC C01B 32/80; B01J 21/18; B01J 37/08

(57) ABSTRACT

The invention relates to a process for producing phosgene by conversion of chlorine and CO over an activated carbon catalyst, wherein the activated carbon catalyst is dried by reducing the water content, where the drying comprises the following steps:
a) contacting the catalyst with an inert gas stream
b) determining the residual moisture content of the catalyst by determining the moisture content in the offgas stream
c) ending the drying process after attainment of the desired moisture content in the offgas stream by switching from the inert gas to the reaction gases and optionally
d) heating up the catalyst bed and/or the inert gas during the drying process.

The invention relates to a process for producing phosgene by gas phase reaction of carbon monoxide and chlorine in the presence of a catalyst, especially in the presence of activated carbon catalyst, in which the catalyst is dried by reducing the water content.

Phosgene is an important auxiliary in the production of intermediates and end products in virtually all branches of chemistry. In particular, phosgene is a widely used reagent for industrial carbonylation, for example in the production of isocyanates or organic acid chlorides. The greatest area of use in terms of volume is the production of diisocyanates for polyurethane chemistry, especially tolylene diisocyanate and diphenylmethane 4,4-diisocyanate.

Phosgene is produced on an industrial scale in a catalytic gas phase reaction of carbon monoxide and chlorine in the presence of a catalyst, for example an activated carbon catalyst, according to the following reaction equation:

CO+Cl₂⇄COCl₂.

The reaction is strongly exothermic with an enthalpy of reaction ΔH of −107.6 KJ/mol. The reaction is typically produced in a shell-and-tube reactor by the method described in Ullmann's Encyclopedia of Industrial Chemistry, in the “Phosgene” chapter (5th ed. vol. A 19, p 413 ff., VCH Verlagsgesellschaft mbH, Weinheim, 1991). According to this, granular catalyst having a grain size in the range from 3 to 5 mm is used in tubes having a typical internal diameter between 35 and 70 mm, typically between 39 and 45 mm. The reaction commences at a temperature of 40 to 50° C., but rises up to 400° C. or more in the tubes and then drops away again quickly. In the reaction, it is customary to use carbon monoxide in excess in order to ensure that all the chlorine is converted and largely chlorine-free phosgene is produced, since chlorine can lead to unwanted side reactions in the subsequent use of phosgene. The reaction can be conducted at ambient pressure, but is generally conducted at an elevated pressure of 200-600 kPa (2-6 bar). In this pressure range, the phosgene formed can be condensed downstream of the reactor with cooling water or other, for example organic, heat carriers, such that the condenser can be operated in a more economically viable manner.

Heat management in the reactor is one of the greatest challenges in phosgene production, which is required for a safe and economically viable process. In general, there are various methods available to dissipate the heat of reaction. Heat management is influenced mainly by a specific reactor design and a catalyst selection or a specific catalyst design that enables rapid removal of the resulting heat of reaction by reduction of heat and mass transfer restrictions.

The prior art describes a multitude of reactor constructions. In general, there is a flow of a heat transfer medium around the catalyst tubes of the shell-and-tube reactor, which removes the resulting heat of reaction from the reactor. It has been found that the removal of heat is improved in the case of crossflow around the catalyst tubes. In order to achieve this, deflecting plates are generally installed in the reactor, which enable crossflow relative to the catalyst tubes of the heat transfer medium by virtue of a meandering flow of the heat transfer medium.

For example, a typical large-scale reactor for production of phosgene is described in international patent application WO 03/072237 A1.

The throughput of the reactor can be determined via what is called the area load or phosgene load of the reactor, which is defined as the amount of phosgene converted per unit time (generally expressed in kg/s), based on the cross-sectional area of the catalyst, i.e. the sum total of the internal cross-sectional areas of the catalyst tubes (generally reported in m²). In order to control the heat of reaction, therefore, the prior art generally describes area loads between 0.5 and 2 kg of phosgene/m²s.

The term “reactor” in the present application includes all components of a plant in which the chemical conversion of carbon monoxide and chlorine gas to phosgene takes place. It is often the case that a reactor in this context is a single component defined by a reactor vessel. However, a reactor in the context of the present application may also comprise two or more components having separate reactor vessels arranged successively (in series), for example. In this case, the space velocity is based on the overall conversion, i.e. on the phosgene stream that leaves the last reactor component, for example the last reactor vessel.

International patent application WO 2010/076208 A1 discloses an optimized arrangement of the catalyst tubes that leads to uniform coefficients of heat transfer over the cross section of the reactor at the interface between the catalyst tubes and the heat transfer medium. This was achievable via a specific alignment of the flow pathways of the heat transfer medium in each reactor cross section. In such a reactor with an optimized heat flow profile, it was possible to achieve the area loads of up to 2.74 kg of phosgene/m²s.

As well as the reactor, the catalyst has a major influence on the efficiency of the particular phosgene production process.

As described in the publication by Mitchell et al. “Selection of carbon catalyst for the industrial manufacture of phosgene”, Catal. Sci. Technol., 2012, volume 2, p. 2109-2115, there is deactivation or burnoff of the catalyst during the synthesis of phosgene, such that a shutdown of the plant and replacement of the catalyst is required after an appropriate operating time. This can firstly be caused by oxidation of carbon by traces of oxygen in the chlorine gas supplied. Secondly, there can also be a reaction of chlorine with the activated carbon catalyst at relatively high temperatures, typically above 300° C., which leads to formation of volatile carbon tetrachloride (CCl₄). Mitchell et al. assessed 7 commercially available carbon catalysts that are recommended by various suppliers for the production of phosgene. The low reactivity of some catalysts was attributed to the mesoporous nature of the catalyst.

In addition, Christopher J. Mitchell et al., in “Selection of carbon catalyst for the industrial manufacture of phosgene”, Catal. Sci. Technol., 2012, volume 2, p. 2109, states that carbon catalysts are used for production of phosgene. In particular, this publication tests various carbon catalysts (porous materials). Two commercial catalysts, namely Chemviron Solcarb 208C DM and Donau Supersorbon K40, have the best catalytic activity.

Normally, activated carbons from natural sources such as coconut shell, wood, olive kernels are used as catalysts. The porous structure of such activated carbons comprises, in particular, micropores (<2 nm) and macropores (>50 nm). The main reaction takes place in the micropores, which constitute a high surface area, while the macropores are responsible for the transport of raw materials within, and of the product outside, the catalyst particle.

The activity of the catalyst depends on a suitable ratio of transport pores and reaction pores and hence of macropores to micropores.

Activated carbon is notable for a very high specific surface area. This is caused mainly by the porous structure and especially by the micropores (<2 nm) (U.S. Pat. No. 9,174,205).

It is known that water can condense in the pores in the case of an appropriate air moisture content. For instance, “https://www.arnold-chemie.de/zeolithe/temperatur-adsorbens-feuchte/” states that activated carbon is basically hydrophobic, but that pore condensation over and above a relative air humidity of 60% assumes an extent that prevents the successful use of the carbon as adsorbent.

The adsorption of water vapor on activated carbon follows the rare V isotherm type, with initially minimal adsorption and then rapid onset of pore filling.”

The patent literature, especially CN204417136, CN107906925 and US2016/0137511, describes various apparatuses for drying of activated carbon in production and before installation, for example, as a catalyst in reactors.

The filling of the reaction tubes for phosgene synthesis with activated carbon is generally effected under ambient air and hence at the corresponding moisture content at that moment. During the filling operation, the activated carbon can bind and possibly condense water. The condensed water on startup of the reactor with chlorine and CO can lead to hydrochloric acid formation and corrosion, or with chlorine to solid deposits in the reactor outlet and downstream systems. Moreover, deactivation has been observed as a result of putting a moist catalyst on stream.

The aim of this application is to overcome the disadvantages of the prior art.

It is a technical object of the present invention to provide a process for the production of phosgene that prevents corrosion damage in plant components, reduces hydrochloric acid formation, avoids solid deposits at the reactor outlet and provides elevated catalyst activity of the catalyst used.

This technical problem is solved by the process of the present claim 1.

The invention accordingly relates to a process for producing phosgene by conversion of chlorine and CO over an activated carbon catalyst, wherein the activated carbon catalyst is dried by reducing the water content, where the drying comprises the following steps:
a) contacting the catalyst with an inert gas stream
b) determining the residual moisture content of the catalyst by determining the moisture content in the offgas stream
c) ending the drying process after attainment of the desired moisture content in the offgas stream by switching from the inert gas to the reaction gases and optionally
d) heating up the catalyst bed and/or the inert gas during the drying process.

In other words, the invention relates to a process for producing phosgene by conversion of chlorine and CO over an activated carbon catalyst, wherein the activated carbon catalyst, before being contacted with the reaction gases chlorine and CO, is dried by reducing the water content, where the drying comprises the following steps:
a) contacting the catalyst with an inert gas stream
b) determining the residual moisture content of the catalyst by determining the moisture content in the offgas stream
c) ending the drying process after attainment of the desired moisture content in the offgas stream by switching from the inert gas to the reaction gases CI and CO and optionally
d) heating up the catalyst bed and/or the inert gas during the drying process.

It has been found that, surprisingly, the above-described process of drying the catalyst very substantially avoids corrosion damage to the reactor and the downstream plant components, and simultaneously achieves a higher activity of the catalyst used. Furthermore, a distinctly lower level of solid deposits is formed at the reactor outlet, such that an extension of the cleaning intervals can be achieved or the cleaning can be conducted more quickly. The actual drying step does mean additional time demands and possibly leads to an extension of the regular shutdown times for maintenance and servicing of the plant, such that intensive drying of the catalyst is typically dispensed with or the drying is conducted merely on completion of the catalyst synthesis on the part of the catalyst supplier. But it has been found that, surprisingly, the effects achieved by the drying, namely a distinct increase in catalyst activity and an extension of reactor lifetime coupled with lower cleaning complexity during a shutdown, more than overcompensate for the additional step of drying and hence justify the additional cost and inconvenience.

It is a feature of the process for producing phosgene by conversion of chlorine and CO over an activated carbon catalyst that the water content of the activated carbon is reduced, where the drying comprises multiple steps.

In step a) of the drying according to the present invention, the catalyst is contacted with an inert gas stream.

In general, it is possible for this purpose to use any catalyst which is inert in relation to the catalyst. What is meant by “inert” in the context of the present invention is that the gas does not itself react with the catalyst and hence no structural or chemical alterations are caused by the contacting of the catalyst with the inert gas.

The inert gas used is preferably Ar, CO₂, CO, N₂ and air or mixtures thereof. The inert gas used is further preferably CO, N₂ and air or mixtures thereof. The inert gas used is more preferably N₂ and air or mixtures thereof. For example, air is used.

In general, the inert gas used may be used in any quality, provided that it fulfills the purpose of drying the activated carbon catalyst by absorption of water. Such a gas is referred to in the context of the present invention as dry inert gas. The inert gas used preferably has a water content of 0.5 mg/m³ to 300 mg/m³, further preferably a water content of 0.5 mg/m³ to 120 mg/m³, further preferably a water content of 0.5 mg/m³ to 40 mg/m³, more preferably a water content of 0.5 mg/m³ to 10 mg/m³. For example, a water content of 12 mg/m³, 9 mg/m³, 7 mg/m³, 5 mg/m³, 3 mg/m³, 2 mg/m³ or 1 mg/m³.

In general, the catalyst can be contacted with an inert gas stream in any reactor or vessel suitable for the purpose. The vessel to be used must merely enable the accommodation of the solid catalyst and the passage of an inert gas stream therethrough. What is meant by contacting in the context of the present invention is contact between solid catalyst phase and the gas phase of the inert gas, where the contacting comprises any form of contact between the two phases, for example flow past or flow through the catalyst bed and flow through the catalyst particles. It is particularly advantageous in the context of the present invention when the dried catalyst does not come into contact with the ambient atmosphere between the vessel in which the catalyst is contacted with an inert gas stream.

The drying is preferably effected in the phosgene production reactor.

In general, the contacting of the catalyst with an inert gas stream, also referred to in the context of present invention as drying or drying process, can be effected at different times with respect to the process of phosgene production, for example after catalyst installation of a fresh unused catalyst into a phosgene reactor prior to startup, or after a plant shutdown on the already used catalyst installed in the phosgene reactor prior to restarting, for example after a planned (maintenance work) or unplanned (faults in plant components) plant shutdown.

The drying preferably follows the installation of a new catalyst in the phosgene reactor prior to startup.

In general, it is possible to use any gas stream which is sufficient to assure effective removal of water from the catalyst and hence effectively reduces the moisture content. In the context of the present invention, the gas stream is the volume flow rate of the gas.

The volume flow rate of the inert gas used for drying is preferably in the range from 0.05 to 1.0 m³ (STP)/h/tube; the volume flow rate of the inert gas used for drying is more preferably in the range from 0.05 to 0.8 m³ (STP)/h/tube; the volume flow rate of the inert gas used for drying is more preferably in the range from 0.1 to 0.7 m³ (STP)/h/tube. For example, it can be 0.55 m³ (STP)/h/tube.

In general, the catalyst can be contacted with the inert gas stream in various ways. The catalyst is preferably contacted continuously with the inert gas stream for the entire duration of the drying with a virtually constant volume flow rate.

In another preferred variant of the contacting of the catalyst with the inert gas stream, the inert gas stream is contacted with the catalyst at a virtually constant volume flow rate for a certain time, preferably between 1 min and 240 min, further preferably between 10 min and 180 min, more preferably between 20 min and 150 min, for example for 90 min, and then the gas feed is stopped and the catalyst-filled vessel or reactor is put under reduced pressure. The reduced pressure applied is preferably maintained for a period between 1 min and 240 min, further preferably between 10 min and 180 min, more preferably between 20 min and 150 min, for example for 60 min. This is preferably followed by contacting again with an inert gas stream, for example air, for a particular period of time, preferably between 1 min and 240 min, further preferably between 10 min and 180 min, more preferably between 20 min and 150 min, for example for 80 min, at a virtually constant volume flow rate. This switching between contacting of the catalyst with an inert gas stream followed by reduced pressure can be repeated several times. This switching between gas stream and reduced pressure is preferably repeated up to 50 times, further preferably up to 20 times, more preferably up to 10 times, for example from 3 to 5 times.

Both the contacting of the catalyst with a continuous inert gas stream for the entire duration of the drying with a constant volume flow rate and switching between a constant inert gas stream and reduced pressure can be performed at elevated temperature to accelerate the drying.

In step d) of the present invention, it is optionally possible to heat up the catalyst bed and/or the inert gas during the drying process.

The drying is preferably effected at an elevated temperature in the range from 60 to 170° C. It is further preferably effected at an elevated temperature in the range from 80 to 160° C., more preferably at an elevated temperature in the range from 90 to 155° C., for example at 152° C. It is immaterial here whether the catalyst is first heated, for example, to a temperature in the range from 80° C. to 160° C. or the inert gas used is preheated to a temperature of, for example, 60° C. to 130° C.

In general, it is also conceivable to combine the two heating methods, namely the heating of the catalyst bed itself and the heating of the inert gas stream. Preference is given to using just one of the heating methods. Particular preference is given to heating the catalyst bed.

Especially preferably, the catalyst bed is heated with the aid of the reactor cooling system. In general, the temperature level to be achieved depends on the cooling medium used in the reactor. Fluid heat transfer media used may be various substances or substance mixtures that are suitable for removal of the heat of reaction, for example, because of their heat capacity or because of their enthalpy of evaporation. Typically, a liquid heat transfer medium is used, such as water, dibenzyltoluene (Marlotherm) or monochlorobenzene.

Preferably, the catalyst bed is heated with the aid of the reactor cooling system up to a maximum of a temperature of 5° C. below the boiling temperature of the cooling medium at standard pressure, more preferably up to a maximum of 8° C. below the boiling temperature of the cooling medium at standard pressure, especially preferably up to a maximum of 10° C. below the boiling temperature of the cooling medium at standard pressure, for example 12° C. below the boiling temperature of the cooling medium at standard pressure.

In step b) of the present invention, the residual moisture content of the catalyst is determined by determining the residual moisture content in the offgas stream.

In general, the measurement of the residual moisture content of the offgas stream can be conducted with the aid of any of the standard test methods for determining moisture content in the prior art.

Relative humidity (relative water vapor content in the air) can be measured with a hygrometer. Absorption hygrometers in particular are in everyday use. These electronic absorption hygrometers are based on the change in electrical properties of a sensor. A distinction is made between capacitative sensors and impedance sensors.

The residual moisture content of the catalyst is preferably determined by a dewpoint measurement in the offgas stream.

Dewpoint measurements can be conducted with mobile handheld devices from CS Instruments (DP 500/DP 510) or from EXTECH (HD550). The devices are provided with a data logger and cover a measurement range from −80° C. to 50° C. These devices measure the current temperature and relative humidity, and then calculate the dewpoint.

Depending on the configuration, the moisture content measurement can be conducted continuously, i.e. in a sustained manner, or discontinuously in the form of samples. Preferably, no sustained measurement is carried out. The drying operation may last for several days since the dry gas at first becomes saturated because of the uptake of water when it first flows through the bed.

With on-spec storage and handling, the fresh carbons intended for use as phosgene catalyst have up to 25% by mass of water in bound form. However, depending on the local air humidity and possibly incorrect handling during storage or incorporation, there can also be water contents in the fresh carbon of up to 30% by mass. In general, the drying in step a) of the present invention can be stopped after a defined period or sequence of changes of state of operation.

In step c) of the present invention, the drying process is ended after the desired moisture content in the offgas stream has been attained.

Preference is given to a desired moisture content of the catalyst at a dewpoint of −10° C. measured in the offgas stream, more preferably at a dewpoint of −25° C., especially preferably at a dewpoint of −40° C.

After the desired moisture content has been attained, the respective drying conditions are switched to the respective reaction conditions by exchanging the inert gas(es) for the reaction gases, preferably CO and Cl₂.

Preferably, the feed stream in the process of the invention has a stoichiometric excess of carbon monoxide to chlorine of 0.001 to 50 mol %, such that virtually full conversion of chlorine is assured. If varying chlorine concentrations in the chlorine feed stream are to be expected, it is better to choose a higher excess of carbon monoxide, but in general the excess is kept as small as possible for reasons of cost, provided that complete conversion of chlorine is still assured.

The feed stream is preferably fed in at an absolute pressure in the range from 0.5 to 20 bar. More preferably, the feed stream is fed in at an elevated pressure, for example at an absolute pressure of 3 to 7 bar (absolute). The higher the pressure of the resulting reaction mixture at the reactor outlet, the higher the level at which the phosgene present in the reaction mixture can be condensed. Preferably, the pressure of the reaction mixture at the reactor outlet is still sufficiently high that the phosgene can be at least partly condensed with cooling water.

In general, there are no restrictions in relation to the catalyst, provided that it is suitable for the production of phosgene. All catalysts for production of phosgene that are known in the prior art may be used as catalysts, for example DONAUCARBON. It is possible to use different catalysts, for example SiC catalysts.

It is preferable to use activated carbon catalysts.

Further preferably, the catalyst is DONAUCARBON.

It is alternatively preferable that the catalyst preferably comprises a porous material composed of carbon, micropores and mesopores, where the micropores have a pore diameter of less than 2 nm and where the mesopores have a pore diameter in the range from 2 to 50 nm; where the volume of the mesopores of the porous material is at least 0.45 ml/g. Preferably, the micropore volume is determined to DIN 66135-2 and the mesopore volume to DIN 66134, and the volume of the mesopores of the porous material is determined by the dual-isotherm Nonlocal Density Functional Theoretical (NLDFT) Advanced Pore Size Distribution (PSD) technique.

Preferably, the ratio of the volume of the mesopores of the porous material relative to the volume of the micropores of the porous material is at least 1:1, more preferably in the range from 1.1:1 to 6:1, more preferably in the range from 1.15:1 to 5:1, more preferably in the range from 1.2:1 to 4:1. It is preferable that the volume of the mesopores of the porous material and the volume of the micropores of the porous material are determined with the aid of the dual-isotherm NLDFT Advanced PSD technique.

Preferably, the ratio of the volume of the mesopores of the porous material relative to the total pore volume of the porous material is at least 0.5:1, more preferably in the range from 0.5:1 to 0.9:1, more preferably in the range from 0.55:1 to 0.85:1, more preferably in the range from 0.6:1 to 0.8:1, more preferably in the range from 0.65:1 to 0.8:1. It is preferable that the volume of the mesopores of the porous material and the total pore volume of the porous material are determined with the aid of the dual-isotherm NLDFT Advanced PSD technique.

Preferably, the volume of the mesopores of the porous material is at least 0.5 ml/g.

With regard to the total pore volume of the porous material, it is preferable that it is in the range from 0.5 to 2.25 ml/g, more preferably in the range from 0.55 to 1.75 ml/g, more preferably in the range from 0.65 to 1.70 ml/g. It is preferable that the total pore volume of the porous material is determined with the aid of the dual-isotherm NLDFT Advanced PSD technique.

Preferably not more than 40%, more preferably not more than 30%, more preferably not more than 25%, preferably not more than 20%, more preferably not more than 15%, preferably not more than 10%, more preferably not more than 5%, more preferably not more than 2.5%, more preferably not more than 1%, of the total pore volume of the porous material is in mesopores having a pore diameter of more than 20 nm.

It is preferable that the volume of the mesopores of the porous material is in the range from 0.50 to 0.54 ml/g, more preferably in the range from 0.51 to 0.53 ml/g, and that the ratio of the volume of the mesopores of the porous material relative to the total pore volume of the porous material is in the range from 0.70:1 to 0.75:1, more preferably in the range from 0.72:1 to 0.74:1. It is preferable that the volume of the mesopores of the porous material and the total pore volume of the porous material are determined with the aid of the dual-isotherm NLDFT Advanced PSD technique.

It is alternatively preferable that the volume of the mesopores of the porous material is in the range from 0.64 to 0.70 ml/g, more preferably in the range from 0.65 to 0.67 ml/g, and that the ratio of the volume of the mesopores of the porous material relative to the total pore volume of the porous material is in the range from 0.72:1 to 0.78:1, more preferably in the range from 0.73:1 to 0.76:1. It is preferable that the volume of the mesopores of the porous material and the total pore volume of the porous material are determined with the aid of the dual-isotherm NLDFT Advanced PSD technique.

Preferably, the volume of the micropores of the porous material, preferably determined by the dual-isotherm NLDFT Advanced PSD technique, is not more than 0.7 ml/g, more preferably not more than 0.6 ml/g.

With regard to the BET-specific surface area of the porous material, it is preferable that this is at least 500 m²/g, more preferably in the range from 500 to 2500 m²/g, more preferably in the range from 550 to 1800 m²/g, more preferably in the range from 600 to 1500 m²/g.

Preferably, the total specific surface area of the porous material, measured by the dual-isotherm NLDFT Advanced PSD technique, is at least 600 m²/g, more preferably in the range from 650 to 2000 m²/g, more preferably in the range from 700 to 1800 m²/g.

Preferably, the specific surface area of the porous material, measured with the aid of the dual-isotherm NLDFT Advanced PSD technique, is in the range from 70 to 250 m²/g, more preferably in the range from 80 to 170 m²/g.

Preferably, the ratio of the specific surface area of the porous material which is formed by the mesopores relative to the total specific surface area of the porous material is in the range from 0.07:1 to 0.40:1, more preferably in the range from 0.07:1 to 0.20:1.

It is preferable that the porous material is a pyrolyzed carbon aerogel.

It is preferable that the porous material is an activated pyrolyzed carbon aerogel.

Preferably from 99 to 100 percent by weight, more preferably from 99.5 to 100 percent by weight, more preferably from 99.9 to 100 percent by weight, the porous material consists of carbon.

Preferably less than or equal to 0.5 percent by weight of the porous material consists of oxygen.

Preferably less than or equal to 0.5% by weight, more preferably not more than 0.1% by weight, of the porous material consists of hydrogen.

Preferably less than or equal to 0.01% by weight of the porous material consists of nitrogen.

Preferably, the ash content of the porous material is less than or equal to 0.1% by weight, more preferably not more than 0.08% by weight, more preferably not more than 0.05% by weight, more preferably not more than 0.03% by weight, more preferably not more than 0.025% by weight, preferably not more than 0.01% by weight, more preferably not more than 0.0075% by weight, more preferably not more than 0.005% by weight, more preferably not more than 0.001% by weight, based on the weight of the porous material, as calculated from the total reflection x-ray fluorescence data.

Preferably, the porous material has a content of impurities of elements having atomic numbers of 11 to 92, measured by total reflection x-ray fluorescence (TXRF), of less than 500 ppm, more preferably less than 300 ppm, more preferably less than 200 ppm, more preferably less than 100 ppm.

In general, the process of the invention can be conducted in any shell-and-tube reactor suitable for the production of phosgene by gas phase reaction of carbon monoxide and chlorine in the presence of a carbon catalyst.

A typical phosgene reactor that can be used for the process of the present invention is disclosed, for example, in international patent application WO 03/072273. The reactor has a bundle of catalyst tubes that are sealed parallel to one another in upper and lower tube sheets in longitudinal direction of the reactor. Hoods are provided at both ends of the reactor, with gas distributors disposed therein. A liquid heat exchange medium is used in the space between the catalyst tubes; deflecting plates are arranged horizontally. The reactor is tubeless in the region of the passage openings since only inadequate cooling of the catalyst tubes would be possible in these regions because of the transition of the coolant flow from transverse to longitudinal throughflow. For the supply and draining of the heat transfer medium, nozzles or part-ring channels are provided. It is optionally possible to use a compensator in the reactor shell in order to compensate for thermal stresses.

A suitable reactor may be divided in longitudinal direction of the catalyst tubes into at least two cooling zones that may be separated from one another, for example by intermediate trays. It is possible to use different heat transfer media in the various cooling zones, the selection of which may be matched to the thermal conditions in the respective cooling zones. It is preferable to use the same heat transfer medium. In that case, it is possible, for example, to use evaporative cooling in a cooling zone having particularly high generation of heat, while liquid cooling is used in another cooling zone. In the case of evaporative cooling, it is preferable not to provide deflecting plates or specially constructed deflecting plates where backup of ascending gas bubbles is prevented.

Fluid heat transfer media used may be various substances or substance mixtures that are suitable for removal of the heat of reaction, for example, because of their heat capacity or because of their enthalpy of evaporation. Typically, a liquid heat transfer medium is used, such as water, dibenzyltoluene (Marlotherm) or monochlorobenzene.

The catalyst tubes of the reactor may have a length L in the range from 1.5 to 12 m, preferably from 2.5 to 8 m.

A suitable reactor for the process of the invention may be equipped with 1000 to 10 000 catalyst tubes and be cylindrical, with an internal diameter of preferably 0.3 to 6 m, further preferably from 2 to 5 m, especially from 2.5 to 4 m.

In the reactor is disposed a bundle, i.e. a large number of catalyst tubes, parallel to one another in longitudinal direction of the reactor.

Each catalyst tube preferably has a wall thickness in the range from 2.0 to 4.0 mm, especially from 2.5 to 3.0 mm, and an internal tubular diameter in the range from 20 to 90 mm, preferably in the range from 30 to 50 mm.

The catalyst tubes consist of corrosion-resistant material, for example stainless steel, preferably duplex steel 1.4462, stainless steel 1.4571 or stainless steel 1.4541, or else of nickel alloys or nickel. Preferably, the tube sheets or the entire reactor are formed from the aforementioned materials, especially from duplex or stainless steel.

However, the reactor shell and the pedestal may also be produced from cheaper metals and metal alloys such as black steel. Components that come into contact with reactants may then be coated with a protective layer of higher-value materials.

The catalyst tubes are secured, preferably welded, in tube sheets in a fluid-tight manner at either end. The tube sheets likewise consist of a corrosion-resistant material, preferably stainless steel, especially duplex steel, more preferably of the same material as the catalyst tubes. The seal to the tube sheets is preferably made by welding. For example, at least two layers of weld seams may be provided per tube, which are produced at offset angles, for example by 180°, such that the start and end of the respective layers are not superposed.

Both ends of the reactor are bounded on the outside by hoods. A hood guides the reaction mixture to the catalyst tubes, and the flow of product is removed by the hood at the other end of the reactor.

In the hood supplied with the reaction mixture, there are preferably gas distributors in order to uniformly distribute the gas stream, for example in the form of a plate, especially a perforated plate.

The catalyst tubes are filled with the solid catalyst. The catalyst charge in the catalyst tubes preferably has a gap volume of 0.33 to 0.6, especially of 0.33 to 0.45. The gap volume is based on the catalyst charge, assuming that the solid-state catalyst is a solid body. The porosity of the catalyst bodies themselves, which may be 50% for example, is not taken into account.

Preferably, the area load of the invention is in the range from 0.5 kg of phosgene/m²s to 6 kg of phosgene/m²s, more preferably in the range from 0.7 kg of phosgene/m²s to 5 kg of phosgene/m²s, even better in the range from 0.7 kg of phosgene/m²s to 4 kg of phosgene/m²s, more preferably in the range from 0.8 kg of phosgene/m²s to 3.5 kg of phosgene/m²s.

The increase in space velocity can be achieved in existing reactors by an appropriate adjustment in the operating parameters, especially by an increase in the volume flow rate of the reactants. However, newly constructed reactors may already be designed in terms of their construction for optimized operation with the intended space velocity.

The increase in space velocity can be achieved by a reduction in the number of catalyst tubes in the reactor with a corresponding extension of the length of the catalyst tubes. For example, halving of the number of the catalyst tubes with the same tube diameter doubles both the space velocity and the tube length. The corresponding reactors are therefore slimmer, meaning that they have a smaller diameter with comparable GHSV, which is advantageous both in terms of production and in terms of the cooling of the catalyst tubes. The higher gas velocity and higher charge length increases the pressure drop in the catalyst tubes, but simultaneously leads to better distribution of the feed stream over all catalyst tubes.

The space velocity can also be achieved for the same phosgene capacity and amount of catalyst, with an unchanged number of tubes, by a reduction in diameter of the individual catalyst tubes and again by a corresponding extension of the catalyst tubes.

Of course, combinations of the two measures are also conceivable, i.e. reduction in the number of tubes and reduction in the tube diameter of the individual tubes.

Preferably, the feed stream in the process of the invention has a stoichiometric excess of carbon monoxide to chlorine of 0.001 to 50 mol %, such that virtually full conversion of chlorine is assured. If varying chlorine concentrations in the chlorine feed stream are to be expected, it is better to choose a higher excess of carbon monoxide, but in general the excess is kept as small as possible for reasons of cost, provided that complete conversion of chlorine is still assured.

The feed stream is preferably fed in at an absolute pressure in the range from 0.5 to 20 bar. More preferably, the feed stream is fed in at an elevated pressure, for example at an absolute pressure of 3 to 7 bar (absolute). The higher the pressure of the resulting reaction mixture at the reactor outlet, the higher the level at which the phosgene present in the reaction mixture can be condensed. Preferably, the pressure of the reaction mixture at the reactor outlet is still sufficiently high that the phosgene can be at least partly condensed with cooling water.

The above-described process of the invention can be implemented particularly easily when the reactor already has a means of purging with a gas installed for removal of phosgene from the reactor system, as already proposed for example (see: Phosgene Safety Practice for design, production and processing-International Isocyanate Inc.; WO2019/048371; Phosgene Safe Practice Guidelines-American Chemistry Council [https://www.americanchemistry.com/Phosgene-Safe-Practice-Guidelines/], WO2019/048371).

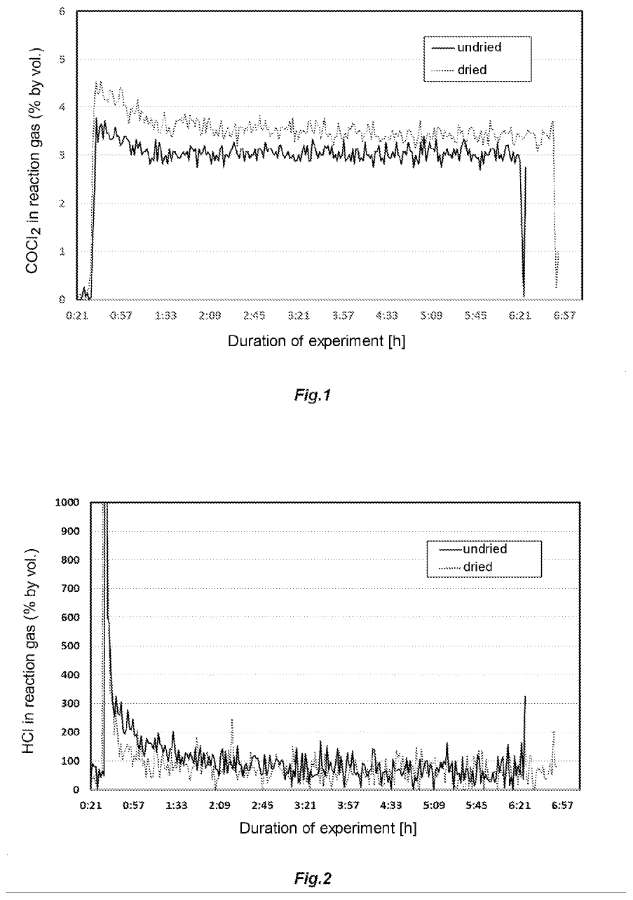

FIG. 1:

Phosgene concentration at the reactor outlet for dried and undried activated carbon. The activated carbon after drying shows up to a 10% increase in activity.

FIG. 2:

HCl concentration at the reactor outlet for dried and undried activated carbon. Elevated HCl formation of the undried carbon at the start of the reactor is apparent here, which leads to corrosion problems especially in the case of contact with water (for example adsorbed water in lower layers of an industrial reaction tube).

### WORKING EXAMPLE

### Example 1 (Comparative Example)

In a reaction tube of diameter 5.4 mm, about 0.4 g of a commercial activated carbon catalyst (Donaucarbon) in the form of pellets between 1-2 mm was installed, which had previously been saturated with water by storage under air. The charge height of the catalyst bed is about 32 mm. The temperature of the reaction tube is controlled by a surrounding copper block.

The reaction tube is supplied with 1.99| (STP)/h of CO, 1.83| (STP)/h of Cl2 and 26.68| (STP)/h of N₂, each from gas bottles. The reaction of the reactants in the reaction tube takes place at 100° C. and about 5 bara over 6 hours. At the reactor outlet, the reaction gases are fed to an IR measurement and the amount of phosgene formed in the mixture is measured. The progression of the phosgene concentration is shown in FIG. 1. After a short startup phase, a constant phosgene concentration averaging 3.04 vol % is established.

### Example 2 (Inventive)

The experiment described in example 1 was repeated, except that, after the filling of the reactor and before the startup of the reactor, the activated carbon bed was dried with a nitrogen stream of 2|(STP)/h at 150° C. over 16 h. Dry nitrogen labeled 5.0 was used from the bottle. This had a dewpoint of −66° C. in a controlled measurement. The offgas stream had a dewpoint of −48° after drying for 16 h. In the dried carbon, after the startup time, a constant phosgene concentration of 3.59 vol % is achieved.

The phosgene concentration likewise shown in FIG. 1, over the total duration of the experiment, has a higher value compared to the undried carbon from example 1. Therefore, the activated carbon after drying shows up to a 10% increase in activity. In FIG. 2, in which the HCl concentration at the start of the reactor is plotted against the duration of the experiment, it becomes clear that the undried carbon according to example 1 shows elevated HCl formation at the start of the reaction, which leads to corrosion problems especially on contact with water (for example adsorbed water in lower layers of an industrial reaction tube).

1.-15. (canceled)

16. A process for producing phosgene by conversion of chlorine and CO over an activated carbon catalyst, wherein the activated carbon catalyst is dried by reducing the water content, where the drying comprises the following steps:
a) contacting the catalyst with an inert gas stream
b) determining the residual moisture content of the catalyst by determining the moisture content in the offgas stream
c) cending the drying process after attainment of the desired moisture content in the offgas stream by switching from the inert gas to the reaction gases and optionally
d) heating up the catalyst bed and/or the inert gas during the drying process.

17. The process according to claim 16, wherein the drying is effected in the phosgene production reactor.

18. The process according to claim 16, wherein the drying is effected after catalyst installation and before startup or after plant shutdown and before restarting.

19. The process according to claim 16, wherein the drying is effected after catalyst installation and before startup of the phosgene reactor.

20. The process according to claim 16, wherein the inert gas is nitrogen or air.

21. The process according to claim 16, wherein the inert gas used for drying has at least one dewpoint of −35° C.

22. The process according to claim 16, wherein the residual moisture content of the catalyst is determined by measuring the dewpoint of the offgas stream at the reactor outlet.

23. The process according to claim 16, wherein the drying is conducted at least down to a dewpoint of −20° C. measured in the offgas stream at the reactor outlet.

24. The process according to claim 16, wherein the offgas stream of the inert gas used for drying is released into the atmosphere.

25. The process according to claim 16, wherein the catalyst is brought to a temperature of 80° C. to 150° C. before and/or during the drying.

26. The process according to claim 16, wherein the inert gas used for drying is preheated to a temperature of 60° C. to 130° C.

27. The process according to claim 26, wherein the inert gas used for drying is preheated to the temperature of 60° C. to 130° C. in mobile heating units.

28. The process according to claim 16, wherein the catalyst is preheated to the desired temperature with the aid of the reactor cooling system.

29. The process according to claim 28, wherein the heating of the catalyst with the aid of the reactor cooling system not more than up to a temperature 10° C. below the boiling temperature of the cooling medium of the reactor cooling system at standard pressure.

30. The process according to claim 16, wherein the volume flow rate of the inert gas used for drying is in the range of 0.05-1.0 m³ (STP)/h/tube.
